(19) United States
(12) Patent Application Publication
(10) Pub. No.: US 2009/0128351 A1
(43) Pub. Date: May 21, 2009

(54) X-RAY SYSTEM CAPABLE OF PREVENTING X-RAY LEAKAGE

(76) Inventor: Qingyu Ma, Beijing (CN)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 12/269,711

(22) Filed: Nov. 12, 2008

(30) Foreign Application Priority Data
Nov. 16, 2007 (CN) 200710169462.6

(51) Int. Cl. G08B 21/00; H05G 1/54

(52) U.S. Cl. 340/686.1; 378/117

(57) ABSTRACT

An X-ray system for preventing X-ray leakage includes a sensor that detects an open/close state of a door of a room, a wireless transmitter that receives the open/close state of the door from the sensor and sends it out in a wireless manner, an X-ray device that emits X-rays, and a wireless receiver, which is provided on the X-ray device, that receives the open/close state from the wireless transmitter and sends it to the X-ray device, wherein the X-ray device controls whether or not to emit X-rays based on the open/close state received from the wireless receiver.

### CROSS REFERENCE TO RELATED APPLICATIONS

This application claims the benefit of Chinese Patent Application No. 200710169462.6 filed Nov. 16, 2007, which is hereby incorporated by reference in its entirety.

### FIELD OF THE INVENTION

The subject matter disclosed herein relates to a radiation protection device, and in particular to an X-ray system capable of preventing X-ray leakage.

### BACKGROUND OF THE INVENTION

For the sake of security, some X-ray systems must have the function of determining whether or not to expose on the basis of the state of the door lock, so as to avoid the event of a ray leakage. Specifically, if the door of the examination room is not closed well, the system will not produce X-rays.

The existing X-ray system capable of preventing X-ray leakage, as shown in FIG. 1, comprises a sensor 10 provided on the door of the examination room, a cable 11 connecting the sensor 10 and the X-ray device 12, the cable 11 being arranged along the wall. The sensor 10 is for detecting whether the door is closed and sending corresponding information through the cable 11 to the X-ray device to control the X-ray device to emit X-rays or not. Although this prior art can achieve the purpose of not producing X-rays when the door is not well closed, it has the following shortcomings. To establish information transmission between the sensor and the X-ray device, the hospital has to arrange a long cable inside the wall when fixing up an operating room, which incurs high cost, and this layout is not suitable for mobile X-ray system. However, if the cable is arranged outside the wall, there will be much inconvenience for moving the mobile X-ray device as the cable 11 is being dragged about on the floor. Besides, the X-ray device cannot be put wherever the doctor desires due to the cable and its limited length. In addition, it is likely that the doctor or nurse may stumble over the cable on the floor when they examine or operate on a patient. This is highly risky. If a doctor wants to move the X-ray device to another operating room, he, at the same time, has to pull the cable out and take it to the other operating room for the next operation. This also brings many encumbrances to the doctor.

It can be seen that the existing X-ray system that is capable of preventing X-ray leakage is not suitable for the use of a mobile device, as it connects the sensor and the X-ray device through a cable. And at the same time such an X-ray system brings much inconvenience to the operators such as doctor/nurse.

### BRIEF DESCRIPTION OF THE INVENTION

Embodiments of the invention described herein provide X-ray systems that prevent X-ray leakage for solving the above problem. Such systems have the function of both facilitating the movement of the X-ray device and preventing leakage of X-rays in an unsafe state.

An X-ray system capable of preventing X-ray leakage in accordance with the present invention comprises: a sensor for detecting the open/close state of the door of the examination room or operating room; an X-ray device capable of emitting X-rays; a wireless transmitter, which receives the information about the open/close state of the door detected by the sensor and sends it out in a wireless manner; a wireless receiver provided on the X-ray device, for receiving the information sent from the wireless transmitter and sending it to the X-ray device; wherein the X-ray device controls whether or not to emit X-rays on the basis of the received information from the wireless receiver.

The wireless transmitter is electrically connected to the sensor.

The X-ray device comprises a workstation and a console having an X-ray tube. The workstation controls the console. The wireless receiver is provided on the workstation, and sends the wireless signal received to the workstation. The workstation processes and sends the information to the console, which, on the basis of this information, controls whether the X-ray tube shall or shall not emit X-rays.

The workstation comprises a central processing unit, the console comprises a microprocessor, the central processing unit receives and processes the information from the wireless receiver and sends it to the microprocessor, which, on the basis of said information, controls whether the X-ray tube shall or shall not emit X-rays.

The console further comprises a notification device, which is connected to and controlled by the microprocessor.

The notification device is a voice broadcaster or a light-emitting diode.

When the sensor detects that the door is open and sends the detected information to the wireless transmitter to be transmitted, the wireless receiver receives the information and sends it through the central processing unit to the microprocessor, which, on the basis of this information, controls the X-ray tube not to emit, and at the same time controls the notification device to give a corresponding voice broadcast information or red flash information indicating that emitting is not allowed. When the sensor detects that the door is closed and sends the detected information to the wireless transmitter to be transmitted, the wireless receiver receives the information and sends it through the central processing unit to the microprocessor, which, on the basis of this information, controls the X-ray tube to emit X-rays, and at the same time controls the notification device to give a corresponding voice broadcast information or green flash information indicating that emission is allowed.

The X-ray device is a C-arm X-ray device, the wireless transmitter is an infrared transmitter and the wireless receiver is an infrared receiver.

The X-ray device is a C-arm X-ray device, the wireless transmitter is a Bluetooth transmitter and the wireless receiver is a Bluetooth receiver.

The X-ray device is a C-arm X-ray device, the wireless transmitter is a wireless USB transmitter, and the wireless receiver is a wireless USB receiver.

The present invention avoids the deficiency of the wired cable transmission in the prior art through the manner of wireless transmission/reception. At the same time, the sensor and wireless transmitter are easy to install/carry, which makes the X-ray device can move more conveniently, thus greatly facilitating the operation of the operator like doctor/nurse. There is no need for adding any equipment when moving from one room to another, so the cost is low. Besides, thanks to the omission of wired cable, the present invention avoids the risk of the operator like doctor/nurse being tripped over by the cable in work, especially in surgical operation.

### BRIEF DESCRIPTION OF THE DRAWINGS

FIG. 1 is a schematic diagram of the state of use of an existing X-ray system capable of preventing X-ray leakage.

FIG. 2 is a schematic diagram of the state of use of the X-ray system capable of preventing X-ray leakage in accordance with the present invention.

FIG. 3 is a schematic block diagram of the X-ray system capable of preventing X-ray leakage in accordance with the present invention.

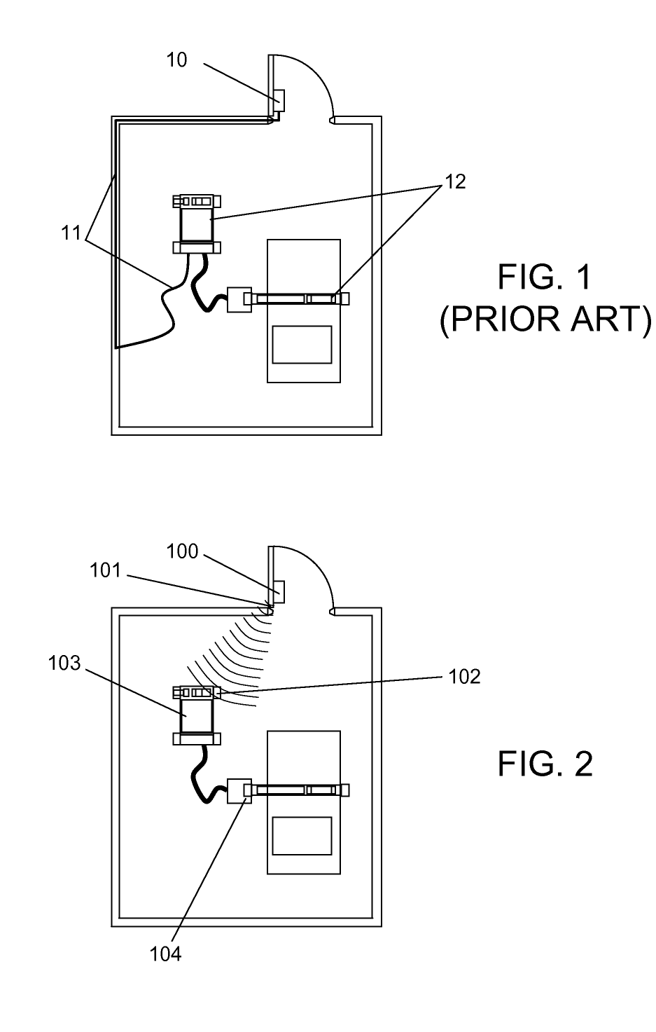

### DETAILED DESCRIPTION OF THE INVENTION

Following are detailed explanations of the embodiments for implementing the present invention with reference to the figures, but the present invention is not limited to these embodiments.

As illustrated in FIG. 2, the X-ray system capable of preventing X-ray leakage in accordance with the present invention comprises a sensor 100, a wireless transmitter 101, a wireless receiver 102 and an X-ray device. The wireless transmitter 101 is electrically connected to the sensor 100. The sensor 100, arranged on the door of the examination room or operating room during operation, is used for detecting the open/close state of the door, and sending the detected state information to the wireless transmitter 101. The wireless receiver 102 is provided on the X-ray device, for receiving the wireless signal sent from the wireless transmitter 101 and sending the signal to the X-ray device. The X-ray device controls the X-ray tube inside it according to the received signal. When the sensor 100 detects that the door is closed, the X-ray device controls the X-ray tube to emit X-rays on the basis of the received information. When the sensor 100 detects that the door is open, the X-ray device controls the X-ray tube not to emit X-rays on the basis of the received information. In this embodiment, the X-ray device is a C-arm X-ray device. The C-arm X-ray device comprises a workstation 103 and a C-arm console 104, the workstation 103 controls the C-arm X-ray console 104, and the X-ray tube is installed inside the C-arm console 104. The wireless receiver 102 is provided on the workstation 103 and is electrically connected thereto.

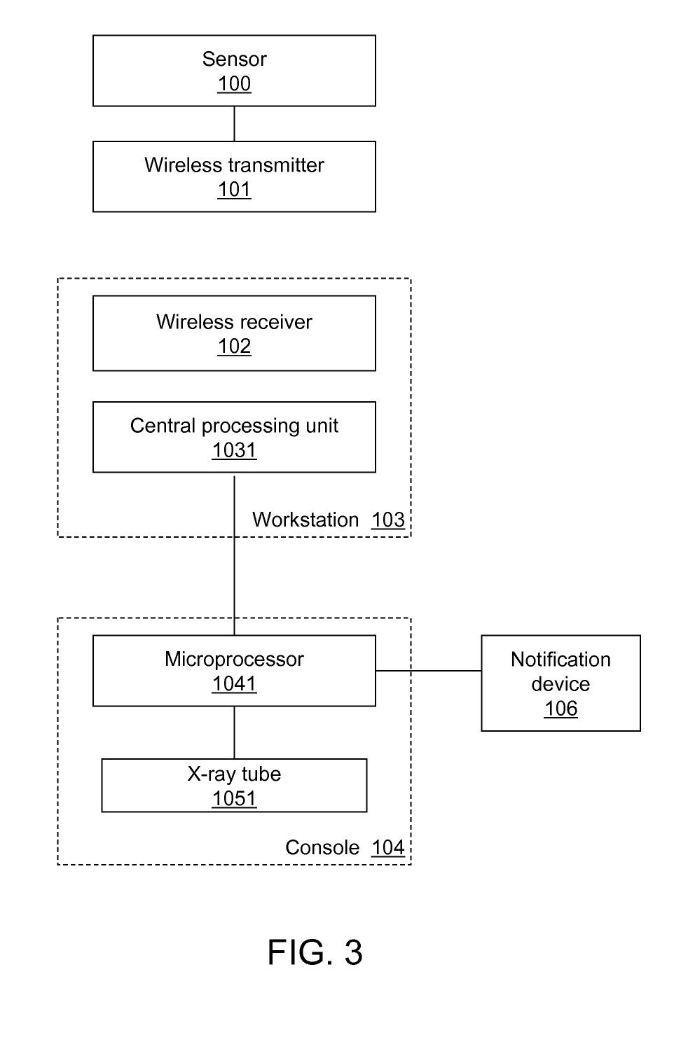

As can be seen in FIG. 3, there is shown a schematic block diagram of an embodiment of the present invention. The sensor 100 sends the detected information about the open/close state of the door to the wireless transmitter 101, and the wireless transmitter 101 sends the information in a wireless manner to the wireless receiver 102. The wireless receiver 102 transforms the received wireless information and sends the transformed information to the central processing unit (CPU) 1031 in the workstation 103. The central processing unit (CPU) 1031 sends the information to the microprocessor 1041 in the C-arm console 104 through its communication interface with the microprocessor 1041. The microprocessor 1041 controls the emission of the X-ray tube 1051 according to said information. When the sensor 100 detects that the door is closed, the microprocessor 1041 controls the X-ray tube 1051 to emit X-rays; when the sensor 100 detects that the door is open, the microprocessor 1041 controls the X-ray tube 1051 not to emit X-rays.

In addition, the present invention further comprises a notification device 106, which is controlled by the microprocessor 1041 to give corresponding information indicating whether emission is allowed or not to the operator like doctor/nurse. The notification device 106 can be a voice broadcaster or a light emitting diode. When the microprocessor 1041 controls the X-ray tube 1051 to emit X-rays, it accordingly controls the notification device 106 to give corresponding information indicating that emission is allowed to the operator like doctor/nurse, such as a voice broadcast information or flashing green light. When the microprocessor 1041 controls the X-ray tube 1051 not to emit X-rays, it accordingly controls the notification device 106 to give information indicating that emission is not allowed to the operator like doctor/nurse, such as a voice broadcast or red light flashing.

The wireless transmitter 101 and wireless receiver 102 in the present invention can transmit signals in such manners as infrared, Bluetooth or wireless USB. Accordingly, the wireless transmitter 101 and wireless receiver 102 are infrared transmitter/receiver, Bluetooth transmitter/receiver, and wireless USB transmitter/receiver respectively.

1. An X-ray system configured to prevent X-ray leakage, said X-ray system comprising:
a sensor configured to detect an open/close state of a door of a room; and
a wireless transmitter configured to receive the open/close state of the door detected by said sensor and to send the open/close state out in a wireless manner;
an X-ray device configured to emit X-rays; and
a wireless receiver coupled to said X-ray device, said wireless receiver configured to receive the open/close state sent from said wireless transmitter and to transmit the open/close state to said X-ray device, wherein said X-ray device is configured to determine whether or not to emit X-rays based on the open/close state received from said wireless receiver.

2. The X-ray system according to claim 1, wherein said wireless transmitter is electrically connected to said sensor.

3. The X-ray system according to claim 1, wherein said X-ray device comprises a workstation and a console comprising an X-ray tube, said workstation is configured to control said console, said wireless receiver is is coupled to said workstation and is configured to send the open/close state received from said wireless transmitter to said workstation, said workstation is further configured to process the open/close state and to send the processed open/close state to said console, which, based on the basis of this information the processed open/close state, is configured to control whether or not said X-ray tube emits X-rays.

4. The X-ray system according to claim 3, wherein said workstation comprises a central processing unit, said console comprises a microprocessor, wherein said central processing unit is configured to receive the open/close state from said wireless receiver, to process the open/close state, and to send the processed open/close state to said microprocessor, which, based on the processed open/close state is configured to control whether or not said X-ray tube emits X-rays.

5. The X-ray system according to claim 4, wherein We said console further comprises a notification device coupled to and controlled by said microprocessor.

6. The X-ray system according to claim 5, wherein said notification device comprises at least one of a voice broadcaster and a light-emitting diode.

7. The X-ray system according to claim 6, wherein when said sensor detects that the door is open, said sensor is configured to send the detected information to said wireless transmitter, said wireless receiver is configured to receive the information and to send the information to said microprocessor via said CPU, said microprocessor, based on the information, is configured to control said X-ray tube such that said X-ray tube does not emit X-rays, and to simultaneously control said notification device to such that said notification device outputs at least one of a corresponding voice broadcast information and a red flash information indicating that emission is not; allowed.

8. The X-ray system according to claim 1, wherein said X-ray device comprises a C-arm X-ray device, said wireless transmitter comprises an infrared transmitter, and said wireless receiver comprises an infrared receiver.

9. The X-ray system according to claim 1, wherein said X-ray device comprises a C-arm X-ray device, said wireless transmitter comprises a Bluetooth transmitter, and said wireless receiver comprises a Bluetooth receiver.

10. The X-ray system according to claim 1, wherein said X-ray device comprises a C-arm X-ray device, said wireless transmitter comprises a wireless USB transmitter, and said wireless receiver comprises a wireless USB receiver.

11. The X-ray system according to claim 7, wherein when said sensor detects that the door is closed, said sensor is configured to send the detected information to said wireless transmitter, said wireless receiver is configured to receive the information and to send the information to said microprocessor via said CPU, said microprocessor, based on the information, is configured to control said X-ray tube such that said X-ray tube is enabled to emit X-rays and to simultaneously control said notification device such that said notification device outputs at least one of a corresponding voice broadcast information and a green flash information indicating that emission is allowed.

12. A method for preventing X-ray leakage, said method comprising:
detecting an open/close state of a door to a room;
transmitting the open/close state in a wireless manner;
receiving, by a wireless receiver coupled to an X-ray device, the open/close state; and
determining whether or not to emit X-rays from the X-ray device based on the open/close state.

13. The method according to claim 12, wherein transmitting the open/close state comprises sending the open/close state from a sensor to a wireless transmitter configured to transmit the open/close state in the wireless manner.

14. The method according to claim 12, wherein the X-ray system includes a workstation and a console, the wireless receiver coupled to the workstation, said receiving the open/close state comprises:
receiving, by the wireless receiver, the open/close state;
processing the open/close state by the workstation; and
sending the processed open/close state to the console, wherein the console is configured to control the emission of X-rays by the X-ray device according to the open/close state.

15. The method according to claim 14, wherein the workstation includes a central processing unit (CPU), said processing the open/close state comprises sending the open/close state from the wireless receiver to the CPU for processing.

16. The method according to claim 15, wherein sending the processed open/close state to the console comprises sending, by the CPU, the processed open/close state to the console.

17. The method according to claim 16, wherein the console includes a microprocessor, said determining whether or not to emit X-rays comprises receiving, by the microprocessor, the open/close state sent by the CPU.

18. The method according to claim 12, further comprising outputting at least one of a voice broadcast and a light according to the determination of whether or not to emit X-rays from the X-ray device.

19. An X-ray device comprising a workstation and a console, said workstation configured to receive an open/close state of a door to a room from a wireless receiver and to send the open/close state to said console, said console configured to control X-ray emission by said X-ray device based on the open/close state, said wireless receiver configured to receive the open/close state from a wireless transmitter coupled to a door sensor.

20. The X-ray device according to claim 19, further comprising a notification device comprising at least one of a voice broadcaster and a light-emitting diode.
